(19) United States
(12) Patent Application Publication
(10) Pub. No.: US 2015/0330273 A1
(43) Pub. Date: Nov. 19, 2015

(54) METHOD AND APPARATUS FOR DIAGNOSING BYPASS VALVE ON OIL COOLING CIRCUIT FOR VEHICLES

(71) Applicants: HYUNDAI MOTOR COMPANY, Seoul (KR); Kia Motors Corporation, Seoul (KR)

(72) Inventors: Young Rock CHUNG, Yongin-si (KR); Sung Ha LEE, Chungju-si (KR); Jung Jae HAN, Gwangmyeong-si (KR)

(21) Appl. No.: 14/554,987

(22) Filed: Nov. 26, 2014

(30) Foreign Application Priority Data
May 16, 2014 (KR) 10-2014-0059128

(51) Int. Cl. F01M 11/10; G01M 15/04; F01M 5/00

(52) U.S. Cl. CPC F01M 11/10; F01M 5/002; G01M 15/048; F01M 2250/60

(57) ABSTRACT

A method for diagnosing a bypass valve on an oil cooling circuit for vehicles includes: a measurement step of measuring a temperature of a downstream oil of the bypass valve, a prediction step, and a diagnosis step. The prediction step compares the temperature of the downstream oil with an opening reference temperature or a closing reference temperature and predicts an open or closed state of the bypass valve. The diagnosis step depending on a result of the prediction step, compares the temperature of the downstream oil with a lowest reference temperature or a highest reference temperature and diagnoses whether the bypass valve is in a failure state in which the bypass valve is stuck in an open or closed state.

### CROSS REFERENCE TO RELATED APPLICATION

The present application claims the benefit of priority to Korean Patent Application Number 10-2014-0059128 filed on May 16, 2014, the entire contents of which application are incorporated herein for all purposes by this reference.

### TECHNICAL FIELD

The present inventive concept relates generally to techniques for diagnosing bypass valves on oil cooling circuits for vehicles and, more particularly, to a method and apparatus for diagnosing a bypass valve on an oil cooling circuit for vehicles which compares the temperature of oil with a limit temperature, at which the bypass valve must be opened or closed, and is able to rapidly and accurately diagnose failure in the bypass valve.

### BACKGROUND

Generally, vehicles are provided with an oil pump to use oil for use in lubrication, cooling, washing, and rust prevention of an engine. The oil pump draws oil from an oil pan containing oil and supplies it to elements requiring the use of oil at a predetermined flow rate and pressure.

Cooling oil using cooling water, an oil cooler is installed between the oil pump and an oil filter. Furthermore, a bypass valve is provided to divert the flow of oil, which is supplied to the oil cooler, depending on the temperature of the oil.

That is, under low-temperature oil conditions, for example, at an initial ignition stage, oil flows with high viscosity. Given this, to prevent power loss caused by mechanical friction of an engine, the bypass valve is actively controlled in such a way that it opens so that oil pumped by the oil pump flows to the engine without passing through the oil cooler whereby the oil can be rapidly warmed up.

On the other hand, under high-temperature oil conditions, the bypass valve is actively controlled in such a way that it is closed so that oil supplied from the oil pump passes through the oil cooler and is thus cooled by heat exchange in the oil cooler.

However, the conventional oil cooler bypass valve is problematic in that, when the bypass valve malfunctions and stops in an open or closed state, it is difficult to accurately diagnose the failure state of the bypass valve.

FIG. 1 illustrates a method for diagnosing failure of an oil cooler bypass valve according to a conventional technique. When the temperature of oil measured at a rear end of an oil cooler is higher than a preset reference value, the bypass valve is diagnosed as being in a failure state (an open stuck state) in which it is stuck in an open state.

However, if a vehicle moves under low-speed and low-load conditions in which the temperature of oil is relatively low, it is difficult to sense an open stuck state of the bypass valve because of a low oil temperature.

In other words, even if an open stuck failure has occurred, only when the vehicle moves under high-speed and high-load conditions can the open stuck failure be sensed. Therefore, the open stuck failure cannot be easily sensed despite the fact that if the vehicle moves in the failure state, fuel efficiency of the vehicle is markedly exacerbated.

The foregoing is intended merely to aid in the understanding of the background of the present inventive concept, and is not intended to mean that the present inventive concept falls within the purview of the related art that is already known to those skilled in the art.

### SUMMARY

An object of the present disclosure is to rapidly and accurately diagnose failure in the bypass valve.

In order to accomplish the above object, in an aspect, the present disclosure provides a method for diagnosing a bypass valve on an oil cooling circuit for vehicles, including: measuring a temperature of oil downstream of the bypass valve; a prediction step of comparing the downstream oil temperature with an opening reference temperature or a closing reference temperature and predicting an open or closed state of the bypass valve; and a diagnosis step of, depending on a result of the prediction step, comparing the downstream oil temperature with a lowest reference temperature or a highest reference temperature and diagnosing whether the bypass valve is in a failure state in which the bypass valve is stuck in an open or closed state.

In certain embodiments, the lowest and highest reference temperatures may be determined from output variables reflecting a driving state and driving conditions of the vehicle.

In the prediction step, when the downstream oil temperature is less than or equal to the opening reference temperature of the bypass valve, the bypass valve is predicted as being in an open state, and when the downstream oil temperature is higher than the closing reference temperature of the bypass valve, the bypass valve is predicted as being in a closed state.

In the diagnosis step, when the downstream oil temperature is less than or equal to the opening reference temperature and is less than or equal to the lowest reference temperature, the bypass valve is diagnosed as being in a failure state in which the bypass valve is stuck in a closed state.

In the diagnosis step, when the downstream oil temperature is higher than both the closing reference temperature and the highest reference temperature, the bypass valve is diagnosed as being in a failure state in which the bypass valve is stuck in an open state.

In another embodiment, the present inventive concept may provide a method for diagnosing a bypass valve on an oil cooling circuit for vehicles, including: measuring a temperature of oil downstream of the bypass valve and a temperature of oil upstream of the bypass valve; a prediction step of comparing the downstream oil temperature with an opening reference temperature or a closing reference temperature, and predicting an open or closed state of the bypass valve; and a diagnosis step of, depending on a result of the prediction step, comparing a difference between the downstream oil temperature and the upstream oil temperature with a lowest limit value or a highest limit value of a difference between the downstream oil temperature and the upstream oil temperature, and diagnosing whether the bypass valve is in a failure state in which the bypass valve is stuck in an open or closed state.

In the prediction step, when the downstream oil temperature is the opening reference temperature of the bypass valve or less, the bypass valve is predicted as being in an open state, and when the downstream oil temperature is higher than the closing reference temperature of the bypass valve, the bypass valve is predicted as being in a closed state.

In the diagnosis step, when the downstream oil temperature is less than or equal to the opening reference temperature, and the difference between the downstream oil temperature and the upstream oil temperature is less than or equal to the lowest limit value, the bypass valve is diagnosed as being in a failure state in which the bypass valve is stuck in a closed state.

In the diagnosis step, when the downstream oil temperature is higher than the closing reference temperature, and the difference between the downstream oil temperature and the upstream oil temperature is higher than the highest limit value, the bypass valve is diagnosed as being in a failure state in which the bypass valve is stuck in an open state.

In certain embodiments, the lowest and highest limit values may be determined from output variables reflecting a driving state and driving conditions of the vehicle. The output variables may include an RPM of an engine, a load of the engine, a temperature of cooling water and a temperature of outdoor air.

In a further aspect, the present inventive concept may provide an apparatus for a bypass valve on an oil cooling circuit for vehicles, including: a temperature sensor configured to measure a temperature of oil downstream of the bypass valve; and a controller which may be configured to compare the downstream oil temperature with an opening reference temperature or a closing reference temperature for opening or closing the bypass valve, predict an open or closed state of the bypass valve; compare, depending on the result of the prediction step, the downstream oil temperature with a lowest reference temperature and a highest reference temperature and diagnose whether the bypass valve is in a failure state in which the bypass valve is stuck in an open or closed state. In an embodiment, the lowest and highest reference temperatures may be determined from output variables reflecting a driving state and driving conditions of the vehicle.

In a still another aspect, the present inventive concept provides an apparatus for a bypass valve on an oil cooling circuit for vehicles, including: a first temperature sensor and a second temperature sensor respectively measuring a temperature of oil downstream of the bypass valve and a temperature of oil upstream of the bypass valve; and a controller which is configured to compare the downstream oil temperature with an opening reference temperature or a closing reference temperature, predict an open or closed state of the bypass valve; compare, depending on the result of the prediction step, a difference between the downstream oil temperature and the upstream oil temperature with lowest or highest limit values of a difference between the downstream oil temperature and the upstream oil temperature, and diagnose whether the bypass valve is in a failure state in which the bypass valve is stuck in an open or closed state. In certain embodiments, the the lowest and highest limit values may be determined from output variables reflecting a driving state and driving conditions of the vehicle.

### BRIEF DESCRIPTION OF THE DRAWINGS

The above and other objects, features and advantages of the present inventive concept will be more clearly understood from the following detailed description taken in conjunction with the accompanying drawings, in which:

FIG. 1 is a flowchart showing a method for diagnosing a bypass valve according to a conventional technique;

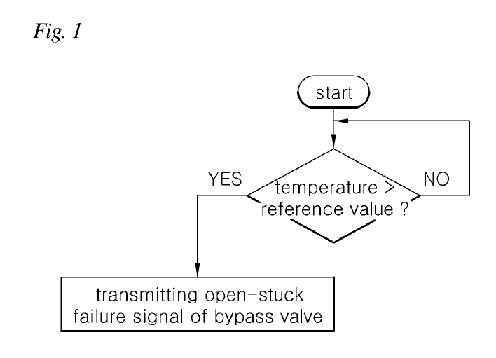

FIG. 2 is a view illustrating the construction for using a first embodiment of a method for diagnosing a bypass valve on an oil cooling circuit for vehicles according to the present inventive concept;

FIG. 3 is a flowchart illustrating the first embodiment of the method for diagnosing the bypass valve according to the present inventive concept;

FIG. 4 is a view illustrating the construction for using a second embodiment of a method for diagnosing a bypass valve on an oil cooling circuit for vehicles according to the present inventive concept;

FIG. 5 is a flowchart illustrating the second embodiment of the method for diagnosing the bypass valve according to the present inventive concept; and

FIG. 6 is a graph illustrating temperature behaviors of oil when the bypass valve is in a normal state and when it is in a failure state according to the present inventive concept.

### DESCRIPTION OF THE PREFERRED EMBODIMENTS

Hereinafter, preferred embodiments of the present inventive concept will be described in detail with reference to the attached drawings.

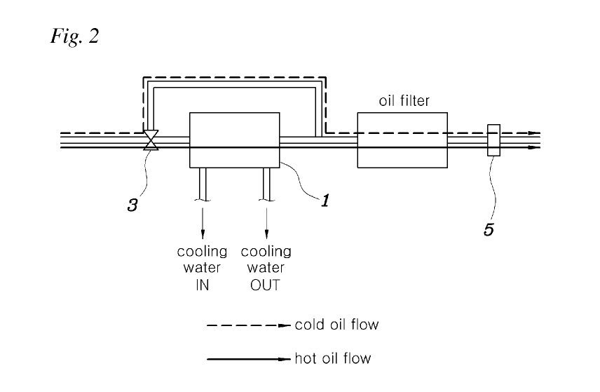

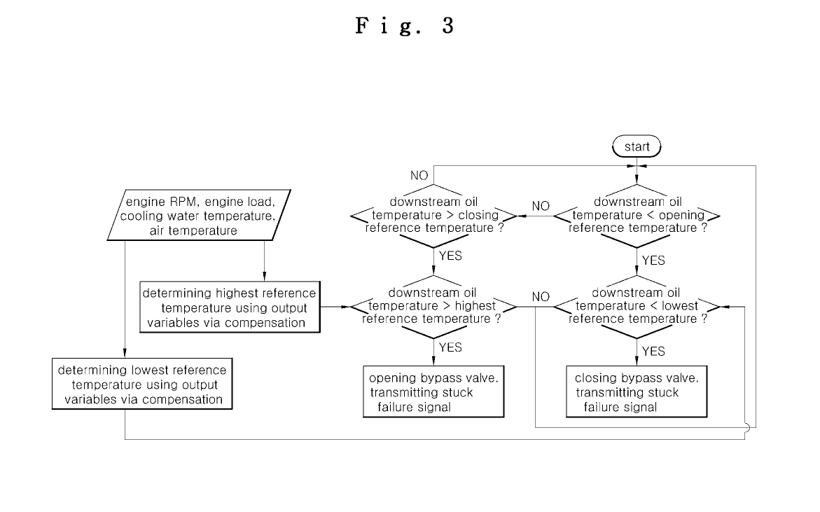

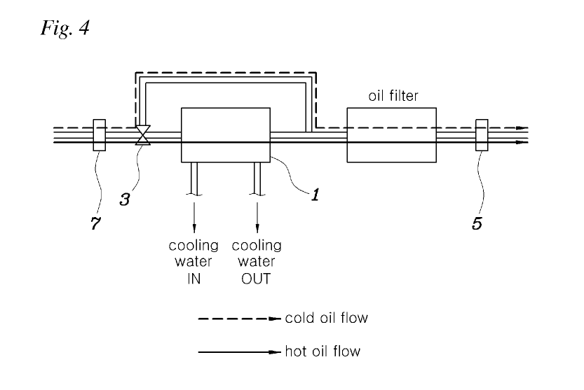

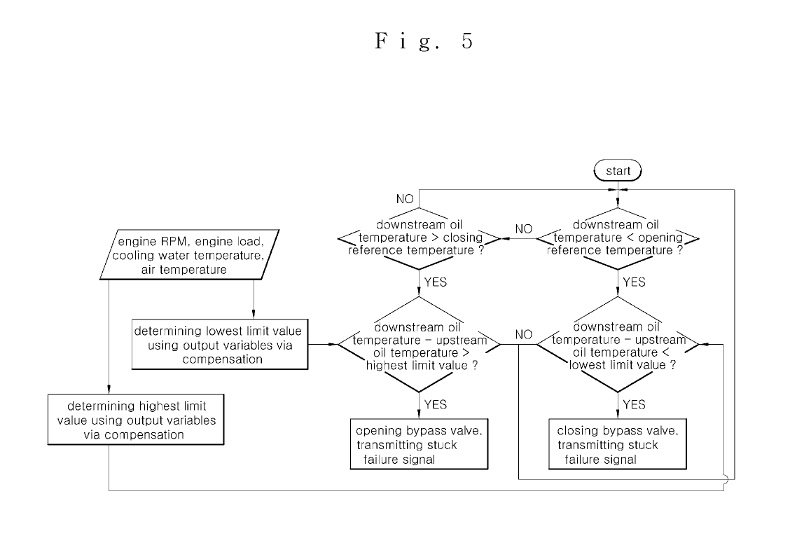

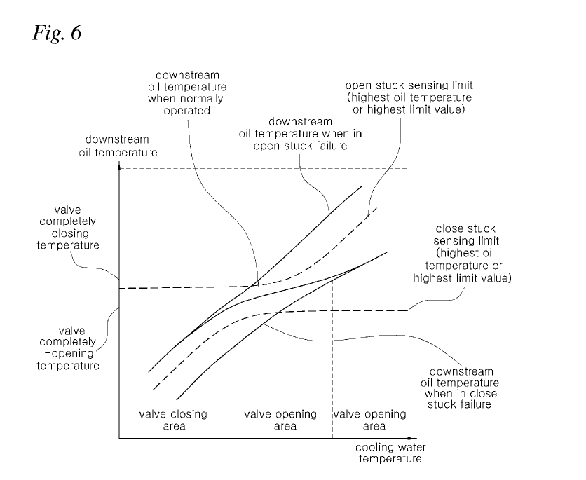

FIG. 2 is a view illustrating the construction for using a first embodiment of a method for diagnosing a bypass valve on an oil cooling circuit for vehicles according to the present inventive concept. FIG. 3 is a flowchart illustrating the first embodiment of the method for diagnosing the bypass valve according to the present inventive concept. FIG. 4 is a view illustrating the construction for using a second embodiment of a method for diagnosing a bypass valve on an oil cooling circuit for vehicles according to the present inventive concept. FIG. 5 is a flowchart illustrating the second embodiment of the method for diagnosing the bypass valve according to the present inventive concept. FIG. 6 is a graph illustrating temperature behaviors of oil when the bypass valve is in a normal state and when it is in a failure state according to the present inventive concept.

The method for diagnosing a bypass valve on an oil cooling circuit for vehicles according to the present inventive concept includes a measurement step, a prediction step and a diagnosis step.

Referring to FIGS. 2 and 3, the method for diagnosing the bypass valve according to a first embodiment of the present inventive concept includes: a measurement step of measuring the temperature of oil downstream of the bypass valve 3; a prediction step of comparing the downstream oil temperature with an opening reference temperature or a closing reference temperature for opening or closing the bypass valve 3, and predicting an open or closed state of the bypass valve 3 when normally operated; and a diagnosis step of, depending on the result of the prediction step, comparing the downstream oil temperature with a lowest reference temperature or a highest reference temperature, which are determined from output variables reflecting a driving state and driving conditions of the vehicle, and diagnosing whether the bypass valve 3 is in a failure state in which the bypass valve 3 is stuck in an open or closed state.

As shown in FIG. 2, the bypass valve 3 according to the first embodiment is provided on an oil cooling circuit. Oil drawn by an oil pump (not shown) is supplied to an oil cooler 1. The oil is cooled in the oil cooler 1 by heat exchange with cooling water in the oil cooler 1.

A bypass passage and the bypass valve 3 are provided on a passage along which oil is supplied to the oil cooler 1. The bypass valve 3 can be controlled such that it is opened or closed depending on the temperature of oil which is measured downstream of the bypass valve 3. In an embodiment, the bypass valve 3 may be an oil thermostat.

A failure state in which the bypass valve 3 is stuck in an open or closed state can be rapidly and accurately diagnosed by comparing the temperature of oil measured downstream of the bypass valve 3 both with the reference temperature at which the bypass valve 3 must be opened or closed and with highest and lowest limit temperatures reflecting the driving state of the vehicle. Therefore, fuel loss which is caused when the vehicle moves in a failure state can be reduced.

In the prediction step, when the downstream oil temperature is less than or equal to an opening reference temperature of the bypass valve 3, the bypass valve 3 is predicted as being in an open state. When the downstream oil temperature is higher than a closing reference temperature of the bypass valve 3, the bypass valve 3 is predicted as being in a closed state.

The opening reference temperature may be a reference temperature at which the bypass valve 3 is completely opened. The closing reference temperature may be a reference temperature at which the bypass valve 3 is completely closed. Of course, the opening reference temperature is set as a temperature lower than the closing reference temperature.

That is, when the downstream oil temperature is the opening reference temperature or less, the bypass valve 3 must be open to prevent oil from being supplied to the oil cooler 1 and cooled by it. Thus, on the assumption that the bypass valve 3 is normally operated, the bypass valve 3 under the above conditions is predicted as being in an open state.

On the contrary, when the downstream oil temperature is greater than the opening reference temperature, the bypass valve 3 must be closed to supply oil to the oil cooler 1 and cool the oil. Hence, in this case, on the assumption that the bypass valve 3 is normally operated, the bypass valve 3 is predicted as being in a closed state.

Particularly, as shown in FIGS. 3 and 6, in the prediction step, when the downstream oil temperature is the opening reference temperature or less and is the lowest reference temperature or less, the bypass valve 3 is diagnosed as being in a failure state in which it is stuck in a closed state.

In other words, when the downstream oil temperature is a low temperature at which the bypass valve 3 must be open, if the bypass valve 3 is normally operated, the bypass valve 3 must be open so that oil bypasses the oil cooler 1. However, if the downstream oil temperature is measured as being the lowest reference temperature or less determined reflecting the driving state of the vehicle, oil is determined as being still cooled by the oil cooler 1. Therefore, the bypass valve 3 is diagnosed as being in a failure state in which it is stuck in a closed state rather than being open.

Furthermore, in the diagnosis step, when the downstream oil temperature is higher both than the opening reference temperature and than the highest reference temperature, the bypass valve 3 is diagnosed as being in a failure state in which it is stuck in an open state.

That is, when the downstream oil temperature is a high temperature at which the bypass valve 3 must be closed, if the bypass valve 3 is normally operated, the bypass valve 3 must be closed so that oil is supplied to the oil cooler 1 and thus cooled by the oil cooler 1. However, if the downstream oil temperature is measured as being higher than the highest reference temperature determined reflecting the driving state of the vehicle, oil is determined as still bypassing the oil cooler 1 rather than being supplied to the oil cooler 1. Therefore, the bypass valve 3 is diagnosed as being in a failure state in which it is stuck in an open state rather than being closed.

Hereinafter, a second embodiment of a method for diagnosing a bypass valve 3 according to the present inventive concept will be described with reference to FIGS. 4 and 5. The method according to the second embodiment includes: a measurement step of measuring the temperature of oil downstream of the bypass valve 3 and the temperature of oil upstream of the bypass valve 3; a prediction step of comparing the downstream oil temperature with an opening reference temperature or a closing reference temperature for opening or closing the bypass valve 3, and predicting an open or closed state of the bypass valve 3 when normally operated; and a diagnosis step of, depending on the result of the prediction step, comparing a difference value between the downstream oil temperature and the upstream oil temperature with lowest and highest limit values of a difference between the downstream oil temperature and the upstream oil temperature, the lowest and highest limit values being determined from output variables reflecting a driving state and driving conditions of the vehicle, and then diagnosing whether the bypass valve 3 is in a failure state in which the bypass valve 3 is stuck in an open or closed state.

As shown in FIG. 4, the bypass valve 3 according to the second embodiment is provided on an oil cooling circuit. Oil drawn by an oil pump (not shown) is supplied to an oil cooler 1. The oil is cooled in the oil cooler 1 by heat exchange with cooling water in the oil cooler 1.

A bypass passage and the bypass valve 3 are provided on a passage along which oil is supplied to the oil cooler 1. The bypass valve 3 can be controlled such that it is opened or closed depending on the temperatures of oil which are measured upstream and downstream of the bypass valve 3. In an embodiment, the bypass valve 3 may be an oil thermostat.

A failure state in which the bypass valve 3 is stuck in an open or closed state can be rapidly and accurately diagnosed both by comparing the temperature of oil measured downstream of the bypass valve 3 with the reference temperature at which the bypass valve 3 must be opened or closed and by comparing a difference between oil temperatures measured downstream and upstream with highest and lowest limit values reflecting the driving state of the vehicle. Therefore, fuel loss which is caused when the vehicle moves in a failure state can be reduced.

In the prediction step, when the downstream oil temperature is an opening reference temperature of the bypass valve 3 or less, the bypass valve 3 is predicted as being in an open state. When the downstream oil temperature is higher than a closing reference temperature of the bypass valve 3, the bypass valve 3 is predicted as being in a closed state.

Here, the opening reference temperature may be a reference temperature at which the bypass valve 3 is completely opened. The closing reference temperature may be a reference temperature at which the bypass valve 3 is completely closed. Of course, the opening reference temperature is set as a temperature lower than the closing reference temperature.

Particularly, as shown in FIGS. 5 and 6, in the diagnosis step, when the downstream oil temperature is less than or equal to the opening reference temperature, and a difference value between the downstream oil temperature and the upstream oil temperature is the lowest limit value or less, the bypass valve 3 is diagnosed as being in a failure state in which it is stuck in a closed state.

In other words, when the downstream oil temperature is a low temperature at which the bypass valve 3 must be open, if the bypass valve 3 is normally operated, the bypass valve 3 must be open so that oil bypasses the oil cooler 1. However, if the difference value between the downstream oil temperature and the upstream oil temperature is measured as being the lowest limit value determined reflecting the driving state of the vehicle or less, oil is determined as being still cooled by the oil cooler 1. Therefore, the bypass valve 3 can be diagnosed as being in a failure state in which it is stuck in a closed state rather than being open.

In the diagnosis step, when the downstream oil temperature is higher than the opening reference temperature, and the difference value between the downstream oil temperature and the upstream oil temperature is higher than the highest limit value, the bypass valve 3 is diagnosed as being in a failure state in which it is stuck in an open state.

That is, when the downstream oil temperature is a high temperature at which the bypass valve 3 must be closed, if the bypass valve 3 is normally operated, the bypass valve 3 must be closed so that oil is supplied to the oil cooler 1 and thus cooled by the oil cooler 1. However, if a difference value between the downstream oil temperature and the upstream oil temperature is measured as being higher than the highest limit value determined reflecting the driving state of the vehicle, oil is determined as still bypassing the oil cooler 1 rather than being supplied to the oil cooler 1. Therefore, the bypass valve 3 is diagnosed as being in a failure state in which it is stuck in an open state rather than being closed.

Furthermore, the output variables may be the RPM of an engine, the load of the engine, the temperature of cooling water and the temperature of the air. The lowest reference temperature, the highest reference temperature, the lowest limit value and the highest limit value can be determined using a table or map to which the output variables are input.

Referring to FIG. 2, a first embodiment of an apparatus for a bypass valve 3 of an oil cooling circuit for vehicles according to the present inventive concept includes a first temperature sensor 5 which measures the temperature of oil downstream of the bypass valve 3, and a controller which: compares the downstream oil temperature with an opening reference temperature or a closing reference temperature for opening or closing the bypass valve 3; predicts an open or closed state of the bypass valve 3 when normally operated; compares, depending on the result of the prediction, the downstream oil temperature with a lowest reference temperature and a highest reference temperature, which are determined from output variables reflecting a driving state and driving conditions of the vehicle; and diagnoses whether the bypass valve 3 is in a failure state in which the bypass valve 3 is stuck in an open or closed state.

Referring to FIG. 4, a second embodiment of an apparatus for a bypass valve 3 of an oil cooling circuit for vehicles according to the present inventive concept includes a first temperature sensor 5 and a second temperature sensor 7 which respectively measure the temperature of oil downstream of the bypass valve 3 and the temperature of oil upstream of the bypass valve 3, and a controller which: compares the downstream oil temperature with an opening reference temperature or a closing reference temperature for opening or closing the bypass valve 3; predicts an open or closed state of the bypass valve 3 when normally operated; compares, depending on the result of the prediction, a difference value between the downstream oil temperature and the upstream oil temperature with lowest and highest limit values of a difference between the downstream oil temperature and the upstream oil temperature, the lowest and highest limit values being determined from output variables reflecting a driving state and driving conditions of the vehicle; and diagnoses whether the bypass valve 3 is in a failure state in which the bypass valve 3 is stuck in an open or closed state.

The first temperature sensor 5 may be disposed on the circuit before a main gallery downstream of the oil cooler. The second temperature sensor 7 may be disposed on the circuit upstream of the oil cooler including an oil pan.

As described above, in the present inventive concept, a failure state in which a bypass valve is stuck in an open or closed state can be rapidly and accurately diagnosed by comparing the temperature of oil measured downstream of the bypass valve both with a reference temperature at which the bypass valve must be opened or closed and with highest and lowest limit temperatures reflecting the driving state of the vehicle. Therefore, fuel loss which is caused when the vehicle moves in a failure state can be reduced.

Although the preferred embodiments of the present inventive concept have been disclosed for illustrative purposes, those skilled in the art will appreciate that various modifications, additions and substitutions are possible, without departing from the scope and spirit of the inventive concept as disclosed in the accompanying claims.

What is claimed is:

1. A method for diagnosing a bypass valve on an oil cooling circuit for vehicles, comprising:
a measurement step of measuring a temperature of a downstream oil of the bypass valve;
a prediction step of comparing the temperature of the downstream oil with an opening reference temperature or a closing reference temperature and predicting an open or closed state of the bypass valve; and
a diagnosis step of, depending on a result of the prediction step, comparing the temperature of the downstream oil with a lowest reference temperature or a highest reference temperature and diagnosing whether the bypass valve is in a failure state in which the bypass valve is stuck in an open or closed state.

2. The method of claim 1, the prediction step further comprising:
predicting that the bypass valve is in an open state when the temperature of the downstream oil is less than or equal to the opening reference temperature of the bypass valve, and
predicting that the bypass valve is in a closed state when the temperature of the downstream oil is higher than the closing reference temperature of the bypass valve.

3. The method of claim 2, the diagnosis step further comprising:
diagnosing the bypass valve as being in a failure state in which the bypass valve is stuck in a closed state when the temperature of the downstream oil is less than or equal to the opening reference temperature and is less than or equal to the lowest reference temperature.

4. The method of claim 2, the diagnosis step further comprising:
diagnosing the bypass valve as being in a failure state in which the bypass valve is stuck in an open state when the temperature of the downstream oil is higher than both the closing reference temperature and the highest reference temperature.

5. A method for diagnosing a bypass valve on an oil cooling circuit for vehicles, comprising:
a measurement step of measuring a temperature of a downstream oil of the bypass valve and a temperature of an upstream oil of the bypass valve;
a prediction step of comparing the temperature of the downstream oil with an opening reference temperature or a closing reference temperature and predicting an open or closed state of the bypass valve; and
a diagnosis step of, depending on a result of the prediction step, comparing a difference between the temperature of the downstream oil and the temperature of the upstream oil with a lowest limit value or a highest limit value of a difference between the temperature of the downstream oil and the temperature of the upstream oil, and diagnosing whether the bypass valve is in a failure state in which the bypass valve is stuck in an open or closed state.

6. The method of claim 5, the prediction step further comprising:
predicting that the bypass valve is in an open state when the temperature of the downstream oil is the less than or equal to the opening reference temperature of the bypass valve, and
predicting that the bypass valve is in a closed state when the temperature of the downstream oil is higher than the closing reference temperature of the bypass valve.

7. The method of claim 6, the diagnosis step further comprising:
diagnosing the bypass valve as being in a failure state in which the bypass valve is stuck in a closed state when the temperature of the downstream oil is less than or equal to the opening reference temperature, and the difference between the temperature of the downstream oil and the temperature of the upstream oil is less than or equal to a lowest limit value.

8. The method of claim 6, the diagnosis step further comprising:
diagnosing the bypass valve as being in a failure state in which the bypass valve is stuck in an open state when the temperature of the downstream oil is higher than the closing reference temperature, and the difference between the temperature of the downstream oil and the temperature of the upstream oil is higher than the highest limit value.

9. An apparatus for a bypass valve on an oil cooling circuit for vehicles, comprising:
a temperature sensor configured to measure a temperature of a downstream oil of the bypass valve; and
a controller configured to
compare the temperature of the downstream oil with an opening reference temperature or a closing reference temperature,
predict an open or closed state of the bypass valve
compare, depending on the result of the prediction, the temperature of the downstream oil with a lowest reference temperature and a highest reference temperature, and
diagnose whether the bypass valve is in a failure state in which the bypass valve is stuck in an open or closed state.

10. An apparatus for a bypass valve on an oil cooling circuit for vehicles, comprising:
a first temperature sensor configured to measure a temperature of a downstream oil of the bypass valve and a second temperature sensor configured to measure a temperature of an upstream oil of the bypass valve; and
a controller configured to
compare the temperature of the downstream oil with an opening reference temperature or a closing reference temperature,
predict an open or closed state of the bypass valve when normally operated,
compare, depending on the result of the prediction step, a difference between the temperature of the downstream oil and the temperature of the upstream oil with lowest and highest limit values of a difference between the temperature of the downstream oil and the temperature of the upstream oil, and
diagnose whether the bypass valve is in a failure state in which the bypass valve is stuck in an open or closed state.

11. The method of claim 1, wherein the lowest reference temperature and highest reference temperature are determined from output variables reflecting a driving state and driving conditions of the vehicle.

12. The method of claim 5, wherein the lowest and highest limit values are determined from output variables reflecting a driving state and driving conditions of the vehicle.

13. The method of claim 11, wherein the output variables comprise an RPM of an engine, a load of the engine, a temperature of cooling water and a temperature of outdoor air.

14. The method of claim 12, wherein the output variables comprise an RPM of an engine, a load of the engine, a temperature of cooling water and a temperature of outdoor air.

15. The apparatus of claim 9, wherein the lowest and highest limit values are determined from output variables reflecting a driving state and driving conditions of the vehicle.

16. The apparatus of claim 10, wherein the lowest and highest limit values are determined from output variables reflecting a driving state and driving conditions of the vehicle.
